(19) United States
(12) Patent Application Publication
(10) Pub. No.: US 2009/0154931 A1
(43) Pub. Date: Jun. 18, 2009

(54) ARRANGEMENT FOR COMPENSATING RAMAN SCATTERING

(75) Inventor: Lutz Rapp, Deisenhofen (DE)

Correspondence Address: K&L Gates LLP, P.O. BOX 1135, CHICAGO, IL, 60690, US

(73) Assignee: Siemens Aktiengesellschaft, Munich (DE)

(21) Appl. No.: 10/596,395

(22) PCT Filed: Nov. 15, 2004
(86) PCT No.: PCT/EP04/52957

§ 371 Date: Jun. 12, 2006

(30) Foreign Application Priority Data
Dec. 11, 2003 (DE) 10358011.5

(51) Int. Cl. H04J 14/02; H04J 14/00

(52) U.S. Cl. 398/94; 398/43

(57) ABSTRACT

A light beam which is used for transmitting a wavelength division multiplex signal is guided to a Bragg grating via an adjustable mirror. According to the angle of incidence of the light beam relative to the longitudinal axis of the Bragg grating, different transmission characteristic curves having different gradients are produced. As a result thereof, scattering of the wavelength division multiplex signal can be compensated. A second controllable mirror enables the damping to be adjusted. A control device effects a rapid correction of the scattering after data signals are connected or disconnected.

### FIELD OF TECHNOLOGY

The present disclosure relates to an arrangement for compensating a scattering of wavelength division multiplex signals induced by “stimulated Raman scattering”.

### BACKGROUND

Stimulated Raman scattering leads to a power transfer from optical data signals with high frequencies to data signals with low frequencies which are transmitted via an optical fiber. Typically the contribution of the stimulated Raman scattering to the transmission function of a fiber, represented logarithmically, can be described as a straight line, the gradient of which is proportional to the power of the Raman source. The Raman scattering causes the individual data signals of a wavelength division multiplex signal to be amplified or attenuated to different degrees in the transmission fiber, as a result of which different signal levels and consequently different signal-to-noise ratios are produced at the receiver.

Different methods are known for compensating the undesirable scattering or, as the case may be, for setting the desired scattering. Thus, for instance, the scattering can be controlled by means of additional Raman sources, whereby the additional Raman sources also output and/or absorb additional power. The scattering can also be compensated by means of controllable filters.

It becomes problematic when channels or entire channel groups are added or disconnected. The same problems arise with planned transmission networks in which optical channels are switched (routed) dynamically via different transmission fibers. If a transmission fiber breaks, it is even possible for an entire transmission band to fail.

An electro-optical component consisting of ferroelectric material is known from the patent U.S. Pat. No. 6,584,260, which is incorporated by reference herein in its entirety. It is possible to achieve a wavelength-dependent transmission by means of different control voltages. However, a disadvantage of the double-refracting structures is the heavy dependence on the polarization of the impinging light.

### SUMMARY

Under exemplary embodiments, an arrangement is disclosed for compensating/adjusting the scattering of wavelength division multiplex signals.

On advantage of said the disclosed arrangement is the ease with which it can be implemented and the short reaction time for compensating the scattering. This is dependent on the microelectromechanical systems and can reach the range of 1 μs-10 μs. A linear damping can be set with the aid of a second microelectromechanical system. A control or regulation means is designed such that the system can react very quickly to changes in the scattering. In order to determine the scattering it is usually sufficient to ascertain the total power of all the signals. The scattering can also be determined by a measurement of the power of a small number of characteristic data signals or control signals. The gradient is calculated on the basis of the known mathematical principles and then the necessary control signals are issued to the microelectromechanical systems in accordance with a required transmission characteristic curve.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a schematic diagram of an arrangement under an exemplary embodiment;

FIG. 2 shows transmission characteristic curves; and

FIG. 3 shows a series circuit of mirror-filter combinations.

### DETAILED DESCRIPTION

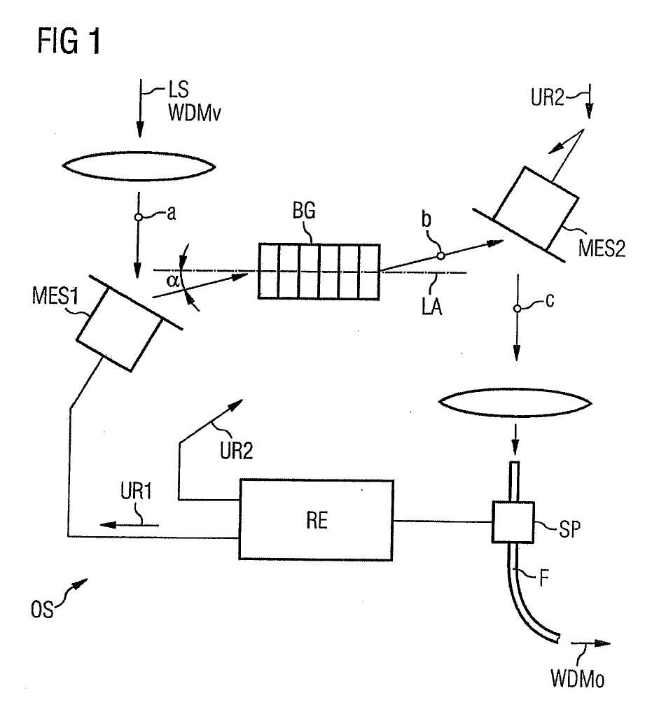

FIG. 1 shows a schematic diagram of an exemplary arrangement, wherein components for guiding light that are not relevant to the invention are not shown. A light beam LS which transmits a wavelength division multiplex signal (WDM signal) WDM_{ν} is guided to a Bragg filter BG via a first mirror MR1. The mirror is part of a first microelectromechanical system MES1 which can change the position of the mirror MR1 such that the light beam LS strikes the Bragg filter at different angles of incidence (injection angles) α relative to the longitudinal axis LA. The Bragg filter BG is designed such that (in the passive state of the mirror, for example) the major part of the light is guided through or the scattering present in the normal case is compensated to a reference value. On the output side the light beam strikes a second mirror MR2 which injects it via a collecting lens OS into a fiber F. Part of the light coupled into the fiber is tapped off in a splitter SP and supplied as a measurement signal to a control or regulating device RE which measures the power of at least some relevant control signals or data signals or the aggregate power of the WDM signal WDM_{ν}, determines the scattering and the level therefrom and adjusts the microelectromechanical systems MES1 and MES2 by means of control voltages UR1, UR2 such that the scattering and the level of the output WDM signal WDM₀ fulfill the requirements. In this case a scattering occurring during the further transmission of the WDM signal WDM₀ via the fiber can already be taken into account, with the result that the data signals of the WDM signal exhibit the same levels and quality at the regenerator or receiver.

An adjustable linear damping element can also be used instead of the second microelectromechanical system MES2 and in principle the position of the Bragg filters can be changed instead of a swiveling of the mirrors being performed.

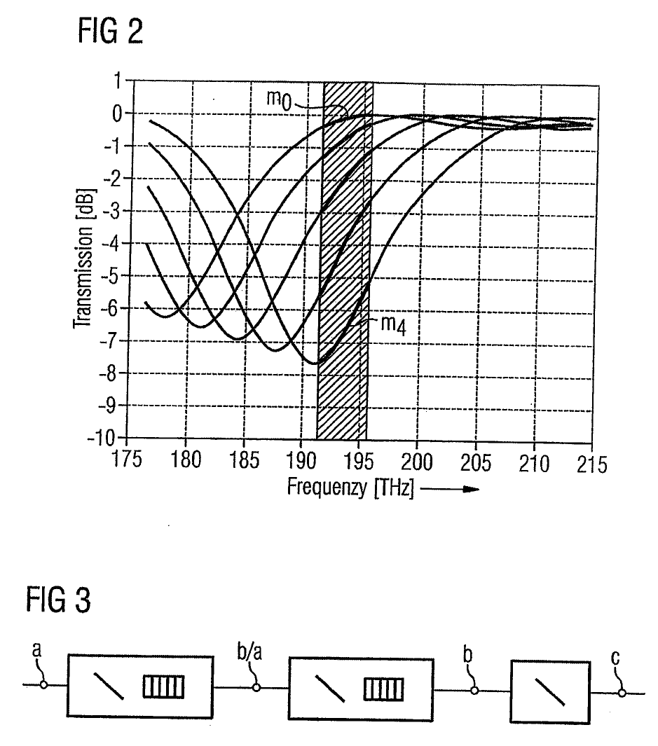

With reference to FIG. 2, the mode of operation of the scattering compensation shall now be explained in greater detail in the first instance. FIG. 2 shows the transmission characteristic curves of a Bragg filter (this should be understood to include all components exhibiting the same filter characteristics) as a function of the frequency spectrum of the light beam or of the frequency of the data signals in terahertz (THz). The transmission band is shaded gray in the diagram. Different transmission characteristic curves are produced as a function of the angle of incidence α of the light beam relative to the longitudinal axis LA of the Bragg grating BG. The highest damping is always achieved when the Bragg conditions are met. The injection of the light at different angles of incidence corresponds to a changing of the grating pitch. If one now considers the transmission characteristic curves in the transmission range at different angles of incidence, it becomes apparent that the transmission characteristic curves are shifted roughly horizontally, as a result of which their gradients m₀-m₄ are different in the transmission range, and that at different gradients they also have different damping values for the data signals (channels). Thus, different scatterings of the WDM signal WDM_{ν} can be compensated or, as the case may be, produced dependent on the angle of incidence, whereby the different dampings can be compensated by means of a linear damping element (and be generated by amplification of the necessary levels). Positive and negative gradients can be realized depending on the implementation of the Bragg grating and range of adjustment of the mirror. The reflected beam can also be used instead of the through-conducted light component, the gradient of said reflected beam in turn running in mirrored fashion with respect to the through-conducted beam.

The damping is preferably generated by swiveling of the second mirror MR2 which operates as a linear damping element in that only a part of the light beam is coupled into the fiber F via the collecting lens OS. Other linear damping elements can be used instead of the second mirror or the compensated WDM signal can be amplified accordingly.

Cascading a plurality of mirror-filter combinations SBG1, SBG2, each of which includes a mirror and a Bragg filter, increases the range of adjustment of scattering and damping. An arrangement of this kind is shown in FIG. 3, with the inputs and outputs being designated by the same lowercase letters a, b and c according to FIG. 1. A further mirror for adjusting the damping can also again be connected downstream of said mirror-filter combinations SBG1, SBG2.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-5. (canceled)

6. An apparatus for compensating the scattering of a wavelength division multiplex (WDM) signal comprising:
a Bragg filter; and
a mirror that changes the angle of incidence of a light beam transmitting the WDM signal relative to the longitudinal axis of the Bragg filter, to effect a wavelength-dependent damping with variable gradient in the transmission range.

7. The apparatus as claimed in claim 6, wherein the Bragg filter is arranged in a fixed position and the mirror is implemented as a first microelectromechanical system.

8. The apparatus as claimed in claim 7, further comprising:
a further microelectromechanical system operatively coupled downstream of the Bragg filter further by means of which linear adjustment of the damping of the WDM signal is achieved.

9. The apparatus as claimed in claim 7, wherein two mirror-filter combinations are connected in series.

10. The apparatus as claimed in claim 6, further comprising a control device that measures the power of at least two control signals or data signals of the WDM signal or the total power of the WDM signal and adjusts the scattering or damping by control of the microelectromechanical systems.
